(19) United States
(12) Patent Application Publication
(10) Pub. No.: US 2009/0157477 A1
(43) Pub. Date: Jun. 18, 2009

(54) System for evaluating an infant's perception of a tactile quality of an article of manufacture

(75) Inventor: Jason C. Cohen, Appleton, WI (US)

Correspondence Address: KIMBERLY-CLARK WORLDWIDE, INC.;Catherine E. Wolf, 401 NORTH LAKE STREET, NEENAH, WI, 54956, US

(73) Assignee: Kimberly-Clark Worldwide, Inc.

(21) Appl. No.: 12/002,032

(22) Filed: Dec. 14, 2007

(51) Int. Cl. G06Q 10/00

(52) U.S. Cl. 705/10

(57) ABSTRACT

Disclosed is a system, method, and device for detecting non-nutritive sucking events produced by an infant; patterns comprising such events (i.e., rhythmic sucking patterns, or RSPs); and relating said events and/or RSPs to an infant's perception of a tactile quality, or a physical property corresponding to that tactile quality. The frequency and/or amplitude and/or other characteristics of non-nutritive sucking can change in response to such inputs. Accordingly, changes to RSPs offer detectable and measurable indicia of an infant's perception of these inputs. Furthermore, such information may be used to support and/or substantiate marketing communications to consumers; to guide selection and/or management of research-and-development programs; to help choose product designs that elicit RSPs identified as correlating with the well being of an infant; and other such uses.

### BACKGROUND

The sense of touch is an important part of most people's lives. Touch can help evoke an emotion, a memory, an object, a person, etc. Or touch can simply be pleasing in and of itself. Accordingly, businesses seek to sell or employ products that help meet consumers' perceived tactile needs. Businesses do this, in part, by spending money and time researching and developing products having textures or tactile qualities desired by consumers and users of such products. Businesses may evaluate softness, surfaces, textures, smoothness, viscousness (as with liquids and gels), friction, and the like by conducting use tests. In these kinds of tests, participants are asked to use products in which tactile perception is deemed important. After the test is over, participants answer questions about the product, including, for example, their perceptions of the products tactile qualities (e.g., how soft a towel or tissue product is). Businesses may evaluate other variables in addition to tactile qualities in such tests. For example, a manufacturer might evaluate the effect different textures and color on use-test participants' perception of various qualitative aspects of a product that's being evaluated. A manufacturer can use various experimental designs when conducting such use tests to evaluate the effect of one or more independent variables on a dependent variable of interest. When the results of such tests are to be used to support an advertising claim, a manufacturer will typically work to ensure that the test and its interpretation comport with applicable guidelines set out in standardized test methods (e.g., ASTM guidelines for product testing), or with accepted practices within a given industry.

Unfortunately, an infant's perception of a product employing different tactile qualities may be difficult to determine and/or quantify. Generally, an infant provides signals as to his or her comfort, well being, or stress level in the form of facial expressions, other physical motions, and sounds. Some signals, such as smiling and cooing, may indicate that the infant is satisfied or happy with current environmental conditions and/or bodily conditions. Other signals, such as crying, generally indicate that the infant is not satisfied with current environmental conditions and/or bodily conditions. Such signals, whether indicative of a positive state of well being (smiling and cooing) or a negative state of well being (crying) may not be quantifiable and/or readily correlatable to the infant's perception of a product's performance.

What is needed is a system, device, and method by which indicia of an infant's perception of the tactile qualities of a product are sensed, quantified, and used to help evaluate the performance of said product. The information obtained with such a system could be used for a variety of purposes, including: comparing a plurality of products employing different tactile qualities (e.g., softness); changing the functional performance and/or technical specifications and/or materials-of-construction of a product in response to the obtained information; communicating messages to consumers regarding the performance of a product based on the obtained information; and conducting, or making decisions with respect to, other research-and-development and/or marketing activities.

### SUMMARY

We have determined that non-nutritive sucking events produced by an infant, and patterns comprising such events (i.e., rhythmic sucking patterns), can be used to help evaluate an infant's perception of the tactile qualities of a substrate. A rhythmic sucking pattern comprises a pattern of individual, non-nutritive, sucking events as evidenced by, for example, an infant sucking on a pacifier. We have confirmed that the frequency and/or amplitude and/or other characteristics of non-nutritive sucking can change in response to certain changes in tactile characteristics. Thus rhythmic sucking patterns, and changes to rhythmic sucking patterns, offer a detectable and measurable signal by which an infant's perception of these characteristics may be characterized.

One version of the invention is a system for evaluating an infant's perception of the tactile qualities of an article of manufacture, the system comprising: a sensor adapted to detect non-nutritive sucking events produced by an infant; an article of manufacture having a tactile quality; and an information device operatively connected to the sensor, said information device adapted to accomplish one or more of receiving, storing, processing, displaying, or transmitting information corresponding to non-nutritive sucking events detected by the sensor concurrent to the infant contacting the article of manufacture.

In other versions of the invention, the sensor is a pressure transducer adapted to detect non-nutritive sucking events. The pressure transducer may or may not be attached directly to the pacifier itself.

In some versions of the invention, the information device is attached directly to the pacifier. In other versions of the invention, the information device is remote from the pacifier. The information device may be operatively connected to the sensor by conductive wire, a pneumatic connection, a hydraulic connection, a connection using a portion of the electromagnetic spectrum, or some combination of these.

One version of a method for evaluating an infant's perception of the tactile qualities of an article of manufacture comprises the steps of: (a) detecting non-nutritive sucking events produced by an infant; and (b) relating the detected non-nutritive sucking events to the tactile qualities of a first article of manufacture.

Another version of a method for evaluating one or more infants' perceptions of the tactile qualities of a plurality of products comprises: repeating steps (a) and (b) as described in the immediately preceding paragraph for a second article of manufacture; and comparing the detected non-nutritive sucking events produced by an infant in relation to the tactile qualities of the first article of manufacture to the detected non-nutritive sucking events produced by an infant in relation to the tactile qualities of the second article of manufacture.

Other methods of the present invention comprise communicating a message based on the relationship between detected non-nutritive sucking events produced by an infant and a tactile quality (e.g., softness) or physical property characterizing that tactile quality (e.g., hand, modulus, friction, stiffness, etc. as physical properties that help characterize softness).

Another representative method of the present invention comprises communicating a message based on the comparison between the detected non-nutritive sucking events produced by an infant in relation to the tactile qualities of the first article of manufacture to the detected non-nutritive sucking events produced by an infant in relation to the tactile qualities of the second article of manufacture. It should be noted, generally, that any relationship between non-nutritive sucking events, and any corresponding rhythmic sucking pattern, to a tactile quality encompasses relationships between nutritive sucking events, and any corresponding rhythmic sucking pattern, to physical properties characterizing that tactile quality.

Another version of the present invention is a message adapted to be communicated, wherein the message comprises information produced using one of the systems of the present invention.

Another version of the present invention is a message adapted to be communicated and referring to a tactile quality or property corresponding to the tactile quality, wherein substantiation of the message is based on non-nutritive sucking events. The term “substantiation” has the definition generally ascribed to it in advertising law, viz., that there is a reasonable basis in fact for the message's content (except for content deemed to be hyperbole or puffery). Where applicable, “substantiation” may implicate standard test methods that help guide manufacturers on the nature of tests and statistical analyses used to support advertising claims (e.g., ASTM E 1958-06, entitled “Standard Guide for Sensory Claim Substantiation”).

Another version of the invention is a research-and-development project directed to selecting a tactile quality for an article of manufacture, wherein said research-and-development project comprises an evaluation of non-nutritive sucking events and relating these events to the presence, absence, or change in one or more tactile qualities.

Another version of the invention is a method for evaluating an infant's perception of the tactile qualities of an article of manufacture, the method comprising the steps of: (a) detecting non-nutritive sucking events produced by an infant concurrent to the infant contacting an article of manufacture; (b) characterizing a property corresponding to a tactile quality of the article of manufacture; and (c) relating the detected non-nutritive sucking events to the characterized property or tactile quality.

In some representative versions of the preceding method the non-nutritive sucking events are detected, at least in part, while the infant is in an environment substantially devoid of sounds. This might be done to minimize sonic stimuli that may confound the results of the evaluation of an infant's perception of a tactile quality. So, for example, the infant may be placed in a quiet room, or other environment that is substantially acoustically isolated. To further enhance such isolation, a pacifier adapted to wirelessly transmit data corresponding to the detected non-nutritive sucking events to a remote information device, such as a computer, may be employed. In this way the computer, as well as human activity surrounding operation of the computer, can be located in a room separate from the environment in which the infant is placed during the evaluation. Alternatively, the infant participant may be in the same room as the researcher or other personnel, along with equipment used to monitor the non-nutritive sucking. For example, the infant might be placed in one end of the room, facing a wall, with research personnel and equipment at the opposite end of the room, with the personnel and equipment not visible to the infant.

To further limit confounding effects, a plurality of pacifier models may be made available, with one pacifier model being selected for conducting the evaluation. In some versions of the invention, the infant's caregiver will select the pacifier model to be employed during the evaluation. Typically the selected pacifier model will correspond to a pacifier model that is generally used by the infant apart from the evaluation. Each of these pacifier models may be made so that they are able to wirelessly transmit data, thereby avoiding wires or other physical connections between the pacifier and an information device used to monitor the evaluation (for those embodiments in which the information device is separate from, and physically connected to, the pacifier). These wires could prove distracting to the infant (e.g., because the wires drape over the infant, or are visually distracting, or tug on the pacifier in some way—potentially affecting infant's rhythmic sucking pattern).

In another version of a method for evaluating an infant's perception of a tactile quality of an article of manufacture, the evaluation is conducted while the infant is sleeping. Such an evaluation should, of course, limit unintended sensory stimuli that might be perceived by the infant during the test (e.g., perceiving movement, color, or other visual stimuli; perceiving sounds; etc.).

These and other versions, embodiments, and examples of the invention are discussed elsewhere in this application.

### DRAWINGS

FIG. 1 representatively illustrates a pacifier adapted to detect non-nutritive sucking events produced by a baby sucking on the pacifier.

FIGS. 2A, 2B, 2C, 26D, 2E, and 2F representatively depict modification of a pacifier into one version of a device adapted to detect non-nutritive sucking events and/or rhythmic sucking patterns.

FIG. 3 representatively depicts modification of a pacifier into one version of a device adapted to detect non-nutritive sucking events and/or rhythmic sucking patterns.

FIGS. 4A and 4B representatively depict modification of a pacifier into one version of a device adapted to detect non-nutritive sucking events and/or rhythmic sucking patterns.

FIGS. 5A and 5B representatively depict another version of a device adapted to detect non-nutritive sucking events and/or rhythmic sucking patterns.

FIG. 6 representatively depicts the interconnected components of one version of a device adapted to detect non-nutritive sucking events and/or rhythmic sucking patterns.

FIG. 7 representatively depicts a version of a system for detecting both non-nutritive sucking events/rhythmic sucking patterns.

Corresponding reference characters indicate corresponding parts throughout the drawings.

### DEFINITIONS

Within the context of this specification, each term or phrase below includes the following meaning or meanings:

The terms “disposed on,” “disposed along,” “disposed with,” or “disposed toward” and variations thereof are intended to mean that one element can be integral with another element, or that one element can be a separate structure bonded to or placed with or placed near another element.

“Graphical user interface” refers to a visual display on, for example, a monitor, computer, hand-held computer or personal-digital assistant, or other such information device, and includes the ways by which a user sees and manipulates information displayed via the interface. For example, a graphical user interface may include a visual representation of an x-y chart, with the x dimension corresponding to time and the y dimension corresponding to pressure or other parameter that correlates with non-nutritive sucking events. The visual representation can be updated periodically so that the visual representation presents a real-time display of the non-nutritive sucking events detected by a pacifier adapted to detect such events.

“Operatively connected” refers to the communication pathway by which one element, such as a sensor, communicates with another element, such as an information device. Communication may occur by way of an electrical connection through a conductive wire. Or communication may occur via a transmitted signal such as an infrared frequency, a radio frequency, or some other transmitted frequency signal. Alternatively, communication may occur by way of a mechanical connection, such as a hydraulic or pneumatic connection.

These terms may be defined with additional language in the remaining portions of the specification.

### DESCRIPTION

### Representative Devices and Sensors for Detecting Non-Nutritive Sucking Events

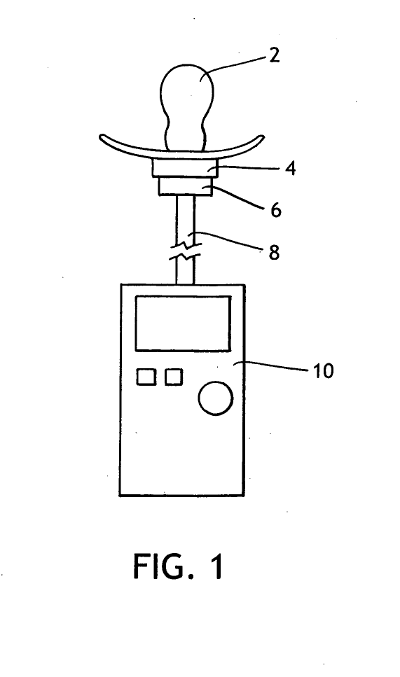

A representative device, adapted to detect non-nutritive sucking events produced by an infant, is depicted in FIG. 1, along with an information device. A nipple 2 is attached to a base 4. A sensor 6 is attached to the base so that an infant's sucking on the nipple is detected. For example, as outlined in the Examples section below, we modified commercially available pacifiers (e.g., a NUK brand pacifier made by NUK, MAPA GmbH, Industriestrasse 21-25, D-27404, Zeven, Germany; a MAM brand pacifier made by MAM Babyartikel GEsmbh, Lorenz-Mandl-Gasse 50, 1160 Wien, Austria; a Disney® brand/The-first-years® brand pacifier made by The First Years, One Kiddie Drive, Avon, Mass.; and a Playtex® brand pacifier, made by Playtex, a business having offices in Allendale, N.J.) by attaching a pressure transducer to the base of each pacifier using an epoxy glue. For a number of pacifiers (e.g., those described in Examples 1-3 below), we used pressure transducers available from Omega Engineering, having offices at One Omega Drive, Box 4047, Stamford, Conn. As discussed below in Examples 1-3, three different pressure transducers, each capable of measuring different ranges of pressure, were used: (1) 0 to 1 pound per square inch (PSI) (model no. PX26-001 GV, which corresponds to 0 to about 16.7 millivolts DC full scale); (2) 0 to 5 PSI (model no. PX26-005GV, which corresponds to 0 to about 50 millivolts DC full scale); and (3) 0 to 15 PSI (model no. PX26-015GV, which corresponds to 0 to about 100 millivolts DC full scale). An epoxy adhesive available from Cole-Parmer Instrument Company, having offices at 625 East Bunker Court, Vernon Hills, Ill., was used to attach the pressure transducer to the base of the pacifier. By operatively connecting the modified pacifier to a digital multimeter available from Fluke Corporation, having offices at 6920 Seaway Boulevard, Everett, Wash. (or, as described below, a computer having an analog-to-digital device), we were able to monitor changes in pressure inside the nipple of the modified pacifier. In FIG. 1, the operative connection is exemplified by a wire 8 connected to an information device 10, in this case the aforementioned multimeter. As mentioned elsewhere, the sensor 6 may be operatively connected to an information device in various ways, including use of a conductive wire, a selected portion of the electromagnetic spectrum (e.g., a wireless connection using radio waves), or a mechanical connection (e.g., a pneumatic connection).

As described in Example 4 below, we have also made pacifiers in which a pressure transducer and wireless transmitter are attached to the base of various pacifier models. As with the pacifiers discussed above, the pressure transducer is in fluid communication with the air within the nipple so that, as described below, changes in pressure due to an infant sucking on the pacifier are detected and wirelessly transmitted to an information device, such as a computer. A representative system for wirelessly monitoring non-nutritive sucking events and corresponding rhythmic sucking patterns effected by an infant is described in Example 6 below.

An infant's sucking on the nipple causes the flexible nipple to stretch or extend, and then return to its original shape. This periodic extending or stretching of the nipple subjects the inside of the nipple to periodic compression, thereby changing the pressure inside the nipple. By operatively connecting a pressure transducer to the volume inside the nipple, the pressure inside the nipple, or a value corresponding to pressure inside the nipple, can be monitored. In some instances, we used a multimeter to display a reading, in millivolts, that corresponded to the pressure inside the nipple. In other cases we used a computer with an analog-to-digital device, and software adapted configure the computer for collecting and processing data, to process and display readings corresponding to the pressure inside the nipple. Additional detail regarding the construction of representative pacifiers adapted to detect non-nutritive sucking events and corresponding rhythmic sucking patterns, and representative versions of systems and other contexts employing such pacifiers, are given elsewhere in the present application, and in the Examples section below.

Other sensors may be used to detect non-nutritive sucking events produced by an infant. For example, a strain gauge could be attached to a pacifier to detect any deflection or deformation of one or more elements of the pacifier (e.g., the nipple; the base to which the nipple is attached; etc.).

Alternatively, a sensor for detecting electrical signals associated with contraction of a muscle or muscle group could be used to detect non-nutritive sucking events produced by an infant. For example, a sensor comprising electrodes and capable of being adhered to skin could be used to detect such sucking events, whether effected by an infant sucking on a pacifier, the nipple on a bottle, the infant's own thumb, finger, or fingers, and the like.

If the non-nutritive sucking events produce sounds, then a device for monitoring audible events could be used to detect the sounds corresponding to non-nutritive sucking events.

While the preceding paragraphs provide examples of devices, sensors, and methods that may be used to detect non-nutritive sucking events produced by an infant, as well as different ways by which infants effect non-nutritive sucking events (e.g., by sucking on a pacifier, a nipple on a bottle, the infant's own thumb, etc.), other devices, sensors, methods, and ways of generating non-nutritive sucking events may be used, so long as the selected approach is capable of detecting the non-nutritive sucking events.

### Representative Information Devices

A multimeter, discussed in the preceding paragraphs and in the Examples section below, is one version of an information device; i.e., a device adapted to accomplish one or more of receiving, storing, processing, displaying, or transmitting information, in this case information corresponding to non-nutritive sucking events produced by an infant, and detected by a sensor. For our work, the multimeter was used in some cases to display a reading, in millivolts, that corresponded to the pressure inside a modified pacifier. An infant's sucking on that pacifier produced a measurable rhythmic sucking pattern (“RSP”)—i.e., a series of millivolt readings that we could plot and evaluate.

A variety of information devices may be used in conjunction with the present invention. For example, a computer may be used to monitor one or more values corresponding to the non-nutritive sucking events produced by an infant. Generally, a computer is capable of receiving, storing, processing, displaying, and transmitting information. Through the use of appropriate software, the computer can be configured to receive, store, process, display, and/or transmit information corresponding to non-nutritive sucking events produced by an infant. In our work, we used a computer to accumulate individual millivolt readings corresponding to individual non-nutritive sucking events. These readings were processed further to calculate an average value for an infant in an environment in which external stimuli remained relatively unchanged; and an average value in an environment in which external stimuli were changed in a controlled fashion (in this case, by contacting an infant with an article of manufacture having a tactile quality). This work is discussed in more detail below, but it is highlighted now to provide an example of how one version of an information device is used to quantify and process non-nutritive sucking events and rhythmic sucking patterns, which can provide indicia of an infant's perception of a tactile quality of an article of manufacture.

Many different information devices may be used with the present invention. In addition to a desktop computer or a device for recording and/or displaying readings corresponding to non-nutritive sucking events (e.g., a multimeter displaying millivolt readings), one could use a personal-digital assistant, hand-held computer, a portable computer, or other compact device to receive, store, process, display, and/or transmit information corresponding to non-nutritive sucking events produced by an infant. Alternatively, a chart recorder or other such device for recording the detected non-nutritive sucking events may be used. As noted above, the information device may comprise a storage device, including, for example, RAM (i.e., Random Access Memory), ROM (i.e., Read-Only Memory), EPROM (i.e., Erasable Programmable Read-Only Memory), PROM (i.e., Programmable Read-Only Memory), RFID (i.e., Radio Frequency IDentification), or the like. Furthermore, information devices comprising storage devices such as those identified in the preceding list may be compact enough to be attached to the sensor used to detect non-nutritive sucking events produced by an infant. For example, an RFID device could be incorporated into a pacifier such that the device recorded the non-nutritive sucking events produced by an infant sucking on the nipple of the pacifier. When desired, an external device could be used to read the stored information on the RFID element. Alternatively, the information on the RFID element could be viewed on a display, either on the pacifier itself, or on a computer or other information device remote from the pacifier. In some versions of the invention, the information device will comprise only a storage device.

In some versions of the invention, a display connected to the sensor itself (e.g. a pacifier having both a pressure transducer to sense the non-nutritive sucking events and an information device comprising a display) could provide an indication or information corresponding to non-nutritive sucking events detected by the sensor and/or stored on the information device. In some examples of the invention, the display could be graphical in nature, with displayed images corresponding to a psychological state or state of well being indicated by non-nutritive sucking events and/or rhythmic sucking patterns. So, for example, if certain rhythmic sucking patterns were generally determined to correspond to a more stressful condition for an infant, then the graphical display on the pacifier might, for example, be an image of a face with a frown. Alternatively, if certain rhythmic sucking patterns were generally determined to correspond to a less stressful condition for the infant, then the graphical display on the pacifier might, for example, be an image of a face with a smile. Furthermore, color might be used, either alone, or in conjunction with graphical images, to convey information regarding the well being, stress level, psychological state, or perceptions of the infant. Any hardware and software capable of presenting a display of information, graphical or otherwise, might be used, including, for example, liquid-crystal displays, light-emitting diodes, and the like. In some versions of the invention, the graphical display is associated with an information device remote from the sensor used to detect non-nutritive sucking events and/or rhythmic sucking patterns (as is discussed in more detail in the following paragraph).

It should be noted that the information device need only be operatively connected to the sensor used to detect non-nutritive sucking events. Accordingly, the information device might be attached to the sensor itself. Or the information device might be at a location remote from the sensor, with information conveyed by an appropriate wavelength in the electromagnetic spectrum (e.g., radio waves); a conductive wire; or some mechanical connection (e.g., a pneumatic or hydraulic connection). In some cases, the information device may comprise one or more components attached to the sensor used to detect non-nutritive sucking events, and one or more components at a location remote from the sensor.

### Representative Approaches to Monitoring an Infant's Perception of a Tactile Quality Of an Article of Manufacture

As discussed above, the present invention is generally directed to systems, devices, and methods for detecting non-nutritive sucking events produced by an infant. One aspect of the present invention is to concurrently monitor non-nutritive sucking events and corresponding rhythmic sucking patterns concurrent to the infant contacting an article of manufacture having a tactile quality. For purposes of this application, “article of manufacture” encompasses a finished product a well as any sub-components, sub-assemblies, or raw materials of the product. Also, “contacting” an infant encompasses a person or device moving an article of manufacture into position so that the article contacts some portion of the infant's body. Alternatively, the infant may “contact” an article by on his or her own initiative.

Of course such physical placement of an article of manufacture in contact with an infant by, for example, a nurse, will, concurrent to the infant's detection of the tactile qualities of the article, potentially result in other sensory stimuli to the infant (e.g., sounds, sights, smells, and perhaps other stimuli associated with the nurse placing the article of manufacture in contact with the infant). One approach to minimizing stimuli that may confound the results of the evaluation is to conduct the evaluation while the infant is sleeping.

One version of a system of the present invention will generally have a sensor for detecting non-nutritive sucking events and/or rhythmic sucking patterns; a sensor for detecting or measuring a physical property that correlates with a tactile quality of an article of manufacture; and one or more information devices for receiving, storing, displaying, processing, and/or transmitting information corresponding to the detected non-nutritive sucking events (and for the detected or measured physical properties).

### Representative Uses of System of Present Invention

Information acquired using a system of the present invention may be used for a variety of purposes. By obtaining information pertaining to the well being, stress level, or other such indicator of an infant's perception of a tactile quality of an article of manufacture, a person or company can elect to develop and transmit messages and/or communications to consumers based on said information. For example, a message could be developed pertaining to comparing indicia of an infant's perception of one texture to another texture (e.g., textures having different softness, smoothness, or other such feature). If differences between these textures resulted in differences in characteristics of individual non-nutritive sucking events or rhythmic sucking patterns (e.g., average amplitude), then a communication to consumers (e.g., caregivers of infants) based on this information could be fashioned. The communication or message could take the form of a newspaper advertisement, a television advertisement, a radio or other audio advertisement, items mailed directly to addressees, items emailed to addresses, Internet Web pages or other such postings, free standing inserts, coupons, various promotions (e.g., trade promotions), co-promotions with other companies, copy and the like, boxes and packages containing the product, and other such forms of disseminating information to consumers or potential consumers.

The above approach could also be used when evaluating an improvement or change to an existing product. For example, a communication or message could be developed pertaining to comparing indicia of an infant's perception of a product or article of manufacture employing one tactile quality to an infant's perception of a product or article of manufacture employing a second tactile quality. If differences in characteristics of individual non-nutritive sucking events or rhythmic sucking patterns (e.g., average amplitude) provide indicia of an infant (or, more likely, populations of infants) perceiving this difference between the two products (or one product with two different tactile qualities), then a communication to consumers based on this information could be fashioned and disseminated as discussed above.

A system of the present invention could also be used to formulate, modify, or terminate a research-and-development project based on the acquired information. If, for example, infants sensing a specific tactile quality provide indicia of an improved state of well being, or lower stress level, compared to other infants (e.g., infants part of a control group not exposed to the tactile quality), then a company could elect to invest in a new research-and-development project in which the well-perceived tactile quality was further developed.

A system of the present invention could be used to evaluate a plurality of design variables for a product. For example, a product, such as a stuffed toy, could be designed to have a given softness/fuzziness and a scent adapted to calm or have some other desired effect promoting an infant's well being. A system of the present invention can be used to evaluate: texture, smoothness, drapability, free-fiber ends, compressibility, friction, and other such tactile qualities (these and other such qualities and corresponding measured properties might be used to characterize solid, fibrous, and other such material; other tactile qualities and corresponding measured properties may be used to characterize liquid and gel materials); and other variables relating to design of a product (e.g., color, scent, etc.). A product designer or researcher can use experimental designs to determine the effects of each of the design variables of interest. The product designer or researcher would look at the effect of changes to these independent design variables on the dependent variable of interest, in this case the characteristics of individual non-nutritive sucking events or rhythmic sucking patterns (e.g., average amplitude or pressure).

Of course the preceding paragraphs provide examples of measurements, tests, use tests, and other ways by which an infant's perception of a tactile quality, or a physical characteristic corresponding to that tactile quality, can be characterized. It should be understood that the present invention may be used to provide indicia of an infant's perception of the performance of a variety of contexts in which a tactile quality is employed.

### EXAMPLES

### Example 1

### Construction of One Version of a Device Adapted to Detect Non-Nutritive Sucking Events and/or Rhythmic Sucking Patterns

A Disney brand pacifier, manufactured by The First Years, One Kiddie Drive, Avon, Mass., was obtained.

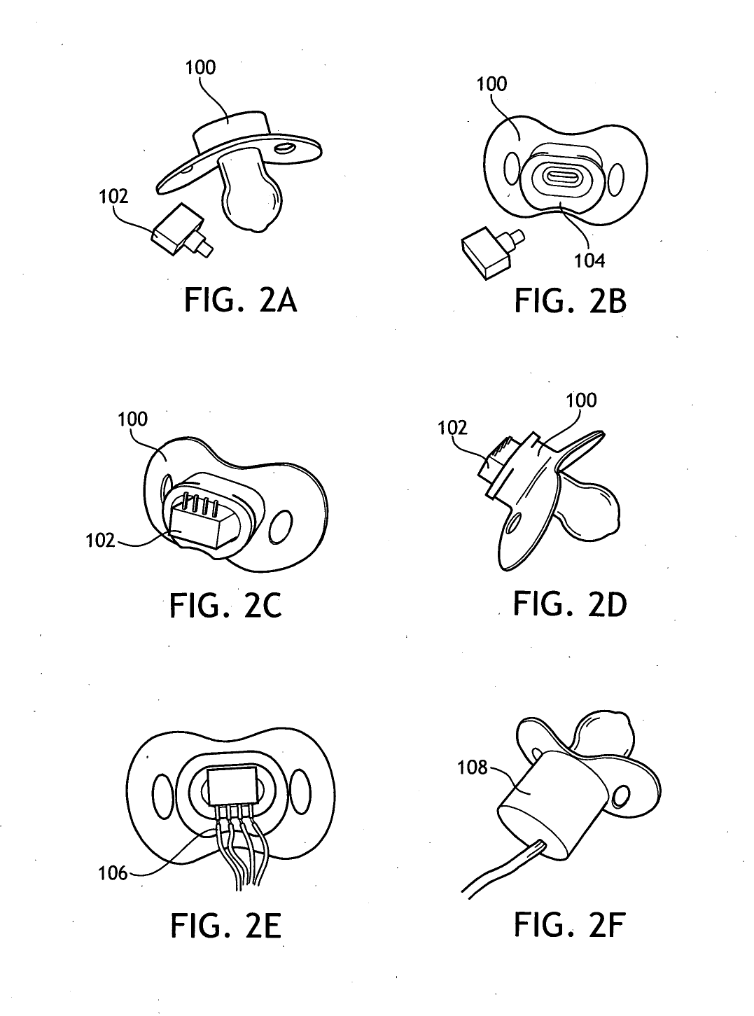

The pacifier was modified as depicted in FIGS. 2A through 2F. FIG. 2A depicts the pacifier 100 along with a pressure transducer 102 obtained from Omega Engineering, having offices at One Omega Drive, Box 4047, Stamford, Conn. This particular pressure transducer (model no. PX26-001 GV) was adapted to detect pressure readings from zero to one pounds per square inch. FIG. 2B depicts the pacifier 100 modified such that the back of the base has been removed to reveal the end of the nipple 104 which is attached to the base.

FIGS. 2C and 2D show the pressure transducer 102 inserted into the opening created by removing the back of the base. In this version of a device adapted to detect non-nutritive sucking events and/or rhythmic sucking patterns, epoxy is used to attach the pressure transducer 102 to the base of the pacifier. A sufficient amount of epoxy was used so that epoxy filled the space between the portion of the transducer that was inserted into the base and the inner wall of the base. I.e., a substantially air-tight seal was formed between the transducer and the base of the pacifier.

FIG. 2E shows a four-conductor ribbon cable 106 soldered to the pressure transducer. FIG. 2F depicts a protective sleeve 108 positioned around the pressure transducer.

Note also that a drill with a # 60 drill bit was used to drill a hole through the solidified epoxy (at a location near the transducer) such that a port to the open end of the nipple was created. The port allowed the nipple to vent air from its interior when squeezed or compressed; and to draw air into its interior when allowed to return to its original shape. The port allowed the nipple to collapse and return to its original shape during use. The port was added because the original, unmodified pacifier had a vent/port, but the original vent was eliminated when we removed the back of the pacifier and attached the transducer with epoxy.

### Example 2

### Construction of Another Version of a Device Adapted to Detect Non-Nutritive Sucking Events and/or Rhythmic Sucking Patterns

A MAM brand pacifier made by MAM Babyartikel GEsmbh, Lorenz-Mandl-Gasse 50, 1160 Wien, Austria, was obtained.

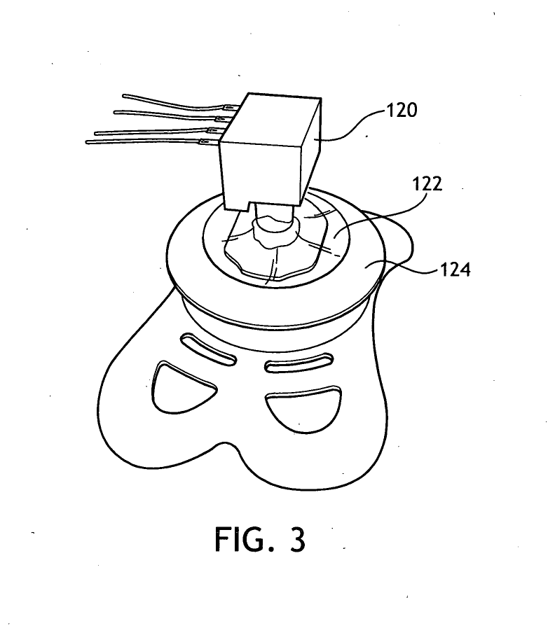

The pacifier was modified as follows. As depicted in FIG. 3, a pressure transducer 120, obtained from Omega Engineering, having offices at One Omega Drive, Box 4047, Stamford, Conn., was attached to the open end 122 of a base 124 of a pacifier. Epoxy was used to attach the pressure transducer to the pacifier. A sufficient amount of epoxy was used so that epoxy filled the space between the portion of the transducer that was inserted into the base and the inner wall of the base. I.e., a substantially air-tight seal was formed between the transducer and the base of the pacifier. This particular pressure transducer was adapted to detect pressure readings of zero to 5 pounds per square inch.

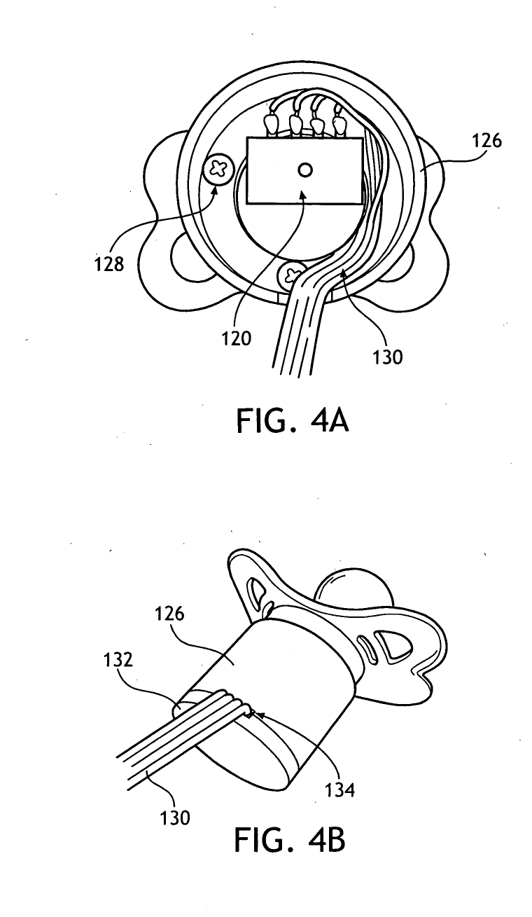

FIG. 4A depicts a protective cup 126 attached to the base of the pacifier using #2-56 screws 128. A four-conductor ribbon cable 130 was soldered to each of the four connectors of the pressure transducer. FIG. 4B shows the modified pacifier with an end cap 132 attached to the protective cup 126. A notch 134 allows for egress of the ribbon cable 130 from the interior of the protective cup 126.

Note also that a drill with a # 60 drill bit was used to drill a hole through the solidified epoxy (at a location near the transducer) such that a port to the open end of the nipple was created. The port allowed the nipple to vent air from its interior when squeezed or compressed; and to draw air into its interior when allowed to return to its original shape. The port allowed the nipple to collapse and return to its original shape during use. The port was added because the original, unmodified pacifier had a vent/port, but the original vent was eliminated when we removed the back of the pacifier and attached the transducer with epoxy.

### Example 3

### Construction of Another Version of a Device Adapted to Detect Non-Nutritive Sucking Events and/or Rhythmic Sucking Patterns

A NUK brand pacifier, manufactured by NUK, MAPA GmbH, Industriestrasse 21-25, D-27404, Zeven, Germany, was obtained.

The pacifier was modified in the same way as the pacifier discussed in Example 2. In this case, however, a pressure transducer capable of detecting 0 to 15 pounds per square inch (0 to 100 millivolt DC, output) was attached to the base of the pacifier. The pressure transducer (model no. PX26-015GV; 0-15 psi) was obtained from Omega Engineering, having offices at One Omega Drive, Box 4047, Stamford, Conn.

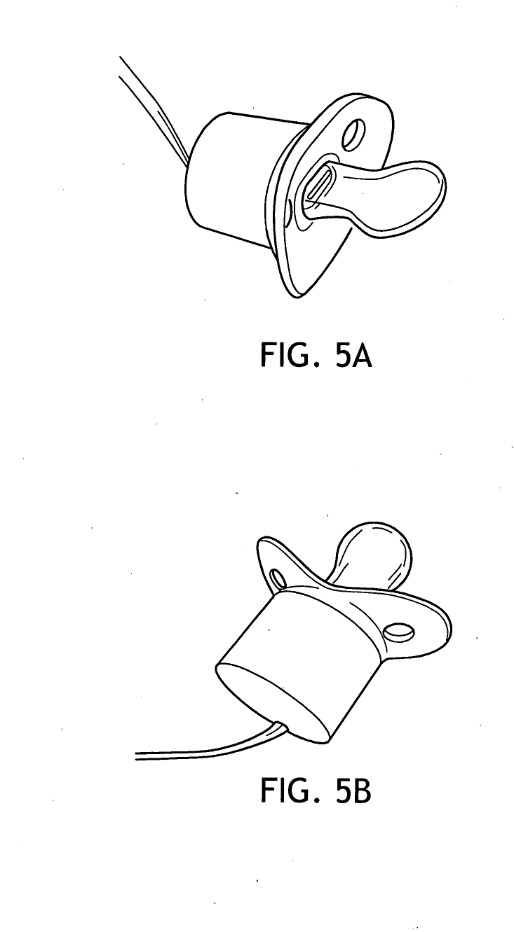

FIGS. 5A and 5B depict two different views of this version of a device adapted to detect non-nutritive sucking events and/or rhythmic sucking patterns.

### Example 4

### Construction of Another Version of a Device Adapted to Detect Non-Nutritive Sucking Events and/or Rhythmic Sucking Patterns

Several pacifiers were modified to include: a battery; a voltage regulator (model number MIC5219, from Micrel, a business having an office in San Jose, Calif.); a pressure transducer (model number 1451-015 G-T, from MSI Sensors, a business having an office in Hampton, Va.); a radio/microcontroller module (in this case one employing a ZigBee® brand standard wireless protocol for transmitting or receiving data in digital form) (model number RC2200AT-SPPIO, from Radiocrafts, a business having an office in Sandakerveien 64, NO-0484 Oslo, Norway); an instrumentation amplifier (model number AD627, from Analog Devices, a business having an office in Norwood, Mass.); and an ultra-precision operational amplifier (model number OP177, from Analog Devices, a business having an office in Norwood, Mass.).

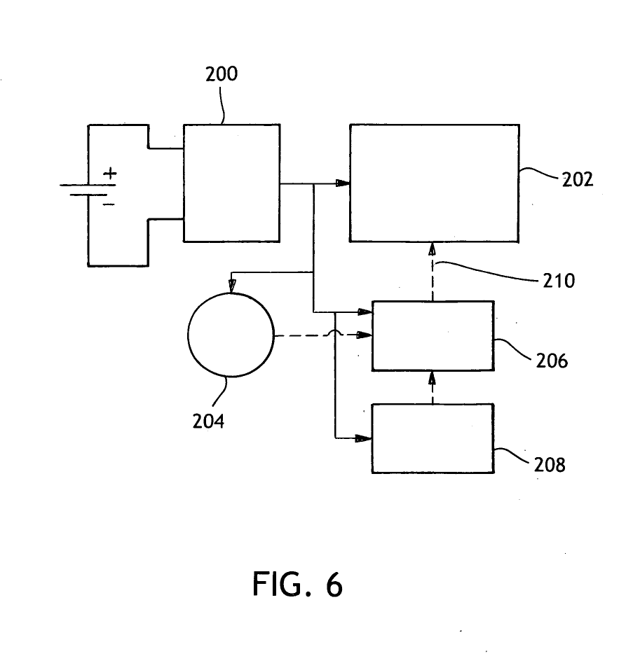

In this representative embodiment, the wireless pacifier was powered by the output of a 3-volt, 500 milli-ampere voltage regulator 200 in FIG. 6. Typically, two 3-volt coin cells configured in series provided the raw unregulated voltage. This was necessary since the regulator needed greater than 3.1 volts to operate. The 3-volt coin cells arranged in series (for a total of 6 volts), as compared to a single 3-volt coin cell, improved the utilization of available batteries.

As noted above, in this representative embodiment of a wireless pacifier, the main component was a ZIGBEE brand ready-radio module, designated as 202 in FIG. 6. This module contained the necessary components for bi-directional wireless communications. The module also contained a microcontroller employing a 10-bit analog-to-digital converter input. The radio and microcontroller worked together to process information and create a wireless serial link between the pacifier and, as discussed below, a computer. The microcontroller engaged the radio at a rate of 10 Hertz to transmit 80 bytes of information, each cycle, for a transmission rate of 800 bytes per second (i.e., a 100 Hertz sampling rate). The 80 bytes of information consisted of 10 packets of 8 bytes each. The binary encoded data was transmitted in hex format (16-byte characters) as follows: byte 0: pacifier wireless module identification; byte 1-3: sample number, with each increment corresponding to 10 milliseconds in time; byte 4-7: pressure in IEEE 754 32-bit format; byte 8: pacifier wireless module identification; byte 9-11: sample number, with each increment corresponding to 10 milliseconds in time; byte 12-15: pressure in IEEE 754 32 bit format.

The pressure transducer 204, which in this representative embodiment was capable of detecting in the range of 0 to 15 gauge pounds per square inch, was of a piezo-resistive silicon type. The transducer employed a bridge network that required voltage excitement. The differential pressure output signal was passed to an instrumentation amplifier 206. The instrumentation amplifier was provided a reference voltage from an ultra-precision amplifier 208 which was configured as a voltage follower fed by a simple voltage divider. The instrumentation amplifier then provided the proper level signal to the module's analog-to-digital converter 210 where its output is adjusted to represent the actual output of the pressure transducer in pounds per square inch, or “PSI.”

The wireless pacifier was prepared much like the wired-in pacifiers described in the previous examples, with the exception that the above components, interconnected as depicted in FIG. 6, were placed in the base of the pacifier. Thus the resulting, modified pacifiers looked generally like that depicted in FIGS. 5A and 5B with the exception, of course, of a wire protruding from the base of the pacifier (because the pacifiers transmitted data in wireless fashion). The pacifiers modified as generally described above included two Disney brand pacifiers, one for ages zero and over, and one for ages 3 months and over, both of which had a silicon nipple; two MAM brand pacifiers, one designated as “Crystal” for ages 6 months and over, and one designated “Pearl” for ages zero to 6 months, both of which had a silicon nipple; two NUK brand pacifiers, one designated for ages zero to 6 months, and one designated for 7 to 18 months, both of which had a latex nipple; and two PLAYTEX brand pacifiers, one designated for ages 3 months and over and having a silicon nipple, and one for the same age range but having a latex nipple.

### Example 5

### One Version of a System for Evaluating an Infant's Perception of a Tactile Quality

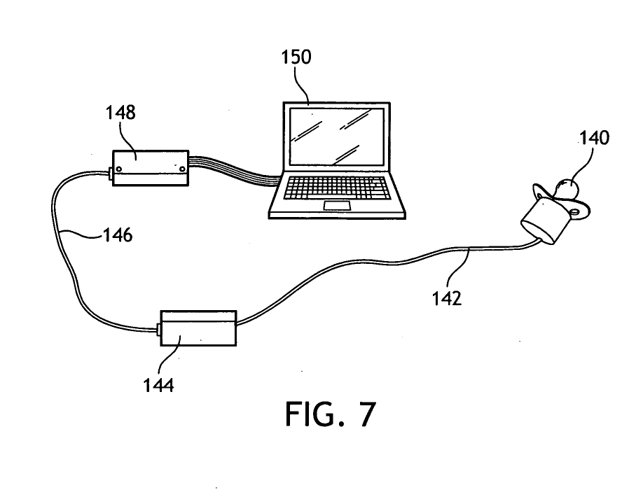

First, a device for detecting non-nutritive sucking events and/or rhythmic sucking patterns was made in accordance with the description in Example 2 above. This device 140 was then connected to other equipment as depicted in FIG. 7. Four wires 142 exit the device (here, a modified pacifier). Two of these four wires were connected to a pair of ten-volt, direct-current batteries. The batteries were used to excite the transducer, and were positioned in a battery holder 144 available from Keystone Electronics Corp., a business having offices in Astoria, N.Y. The two remaining wires 146, which were associated with a 0 to 50 millivolt analog output from the pressure transducer, were connected to an analog-to-digital interface 148, in this case model number NI DAQCard-6036E (for PCMCIA; 200 kS/s, 16-bit, 16 Analog input multifunction DAQ), available from National Instruments Corp, a business having offices at North Mopac Expressway, Austin, Tex. It should be noted that other signal outputs, including analog signal outputs from pressure transducers, may be used, including, for example, AC voltage, DC voltage, AC current, or DC current. In addition, while not done here, the output signal may be amplified using appropriate electronic devices to boost the voltage or current to a higher value which is directly proportional to the pressure applied. Still another possible adaptation would be to utilize an apparatus commonly know as a voltage- or current-to-air pressure transducer (i.e. “I/P”, or “V/P” transducer) to change a pressure transducer's analog voltage or current output signal to a mechanical signal such as a pneumatic air pressure output or a hydraulic pressure output in proportion to the analog signal input. For example, a 4-20 milliamp DC signal output from a pressure transducer can produce a proportional 3-15 PSI pneumatic signal output to enable or facilitate a mechanical motion (e.g., to perform a physical tack, or tasks).

The analog-to-digital interface does what its name states: it converts analog signals into a digital format that can be processed by, for example, a computer. The bit-rate conversion of the interface can be selected to provide adequate conversion of the signal from analog to digital. As noted with the selected interface identified above, we selected an interface with the capability of 16 bits per channel. The sampling frequency may be selected to accurately capture the frequency of the individual non-nutritive sucking events, and associated rhythmic sucking patterns, being produced. Generally, choosing a sampling frequency that is twice that of the frequency of the event (Nyquist criterion) will present a lower range for sampling frequency. Other sampling frequencies include 100 times the Nyquist criterion or 1000 times the Nyquist criterion (e.g., 1000 Hertz). Additionally, to reduce our requirements for handling large amounts of data (e.g., when displaying the data visually), we at times filtered, i.e., reduced, the data to a frequency of 4 Hertz.

Here the analog-to-digital interface was connected to a Compaq EVO NG10C computer (designated by the number 150 in FIG. 7). LabView software, version 6.1, was obtained from National Instruments. LabView software configures a computer to acquire, store, process, and display data transmitted to the computer from various sources, in this case digital values transmitted from the analog-to-digital converter. In this case, the software was used to process digital information corresponding to the analog signals, in millivolts, effected by an infant sucking on a modified pacifier equipped to detect non-nutritive sucking events.

### Example 6

### One Version of a System for Evaluating an Infant's Perception of a Tactile Quality

The representative system is much like that in the previous example, but which operates wirelessly. Accordingly, a pacifier like that described in Example 4 is employed, which, as noted above, wirelessly transmits data, including pressure, to a computer. The receiver for the wireless-pacifier system is a Chipcon (headquarter in Oslo, Norway) model CC2420 DB ZIGBEE demonstration board. This board is connected to a computer (identified below) through a RS-232 interface which uses 9-pin D-Subminiature connectors and was powered by an AC adapter. As the demonstration board receives packets of information, it relays this information back to the computer through the RS-232 connection at a baud rate of 57.6K. The computer used was a Hewlett-Packard nc6220, and LabView 8.2 software was used to collect the data from the RS-232 interface, display, and store the data.

### Example 7

### Test Showing Change in Rhythmic Sucking Pattern in Response to Different Tactile Qualities

At a clinical research facility, a caregiver, in this case the infant's parent, carried the infant to be observed into a room. The infant remained in a car seat/portable carrier for the evaluation. The seat was placed on a table at one end of the room, with the seat positioned so that the infant's field of view was directed toward a nearby wall. The infant was in a reclined position, with the infant's head higher than his or her feet. A computer for monitoring non-nutritive sucking events and corresponding rhythmic sucking patterns was located at the other end of the room. During the test the infant could not see any activity by a researcher, or the equipment used to monitor data transmitted by a wireless pacifier. The caregiver remained in a position such that the infant saw the caregiver, at least while the infant remained awake.

The infant was given one of the pacifiers described in Example 4 above. The caregiver selected a pacifier that was the same or similar to the unmodified pacifier typically used by the infant apart from the evaluation. After the caregiver gave the infant the wireless pacifier, the infant began sucking on the pacifier, thereby producing non-nutritive sucking events. The pressure transducer inside the pacifier detected pressure changes corresponding to these sucking events, with the pressure, in pounds per square inch, being transmitted to a computer (along with other information, identified above in Example 4). The computer was configured, using appropriate software—in this case LabView software, version 8.2, from National Instruments—to acquire, store, process, and display data being transmitted from the wireless pacifier (see Example 6 above for additional information on the system used for this evaluation). In this case the data was displayed on an x-y plot, with the y dimension corresponding to pressure in pounds per square inch, and the x dimension corresponding to time.

First non-nutritive sucking events effected by the infant were monitored to obtain a baseline for future comparisons (i.e., comparisons between the pattern of non-nutritive sucking events obtained in the absence of a controlled external stimulus and the pattern of non-nutritive sucking events obtained in the presence of a controlled external stimulus). As stated above, the mother of the infant was visible to the infant at all times. After the infant entered a light sleep (as evidenced by the infant closing his eyes), a baseline value corresponding to an average pressure was obtained. I.e., after one or two minutes the pattern of individual non-nutritive sucking events was stable and regular, and had the appearance of a repeating wave-form pattern (with the amplitude of each wave corresponding to a pressure increase, followed by a subsequent decrease, due to the infant periodically sucking on the pacifier). As discussed earlier, each suck flexes the nipple of the pacifier, causing a pressure change inside the nipple. The sensor selected for this exemplary system, a pressure transducer, detects these pressure changes.

After having established a baseline rhythmic sucking pattern, and with the infant still asleep—as evidenced, in part, by the infant's eyes remaining closed, a nurse contacted the skin of the infant at either the lower leg or lower arm with one of three substrates (a dry tissue—Kleenex-brand tissue; a warm wet tissue—Kleenex-brand tissue immersed in saline solution at 37±2 degrees Celsius, with the tissue then being squeezed to remove excess water; and a wet wipe—Huggies-brand Natural-care, fragrance-free wet wipe at room temperature (22±2 degrees Celsius.). The nurse chose that portion of the body to which she could gain access with the least amount of disruption to the infant. The nurse maintained contact between the substrate and the skin of the infant for a ten-second interval. During this time the nurse moved the tissue or wipe back and forth to simulate a caregiver wiping the child's skin. The nurse sought to apply the same pressure for all samples, and sought to move the sample the same distance each time (3 inches in one direction, followed by 3 inches in the reverse direction). For all but one of the infants, the infants remained asleep while the nurse contacted the infant with a sample substrate in this manner.

The information device used to monitor the non-nutritive sucking events employed a graphical user interface in which the sucking events were displayed, as described above, as a function of time, concurrent to the infant participant's exposure to the tactile source. The researcher monitoring the information device, in this case a computer, marked the time at which the tested substrate was placed in contact with the infant's skin. Any changes to the non-nutritive sucking events, and the corresponding rhythmic sucking pattern, were monitored concurrent to, and after, the infant was exposed to the tactile source.

The resulting data was then analyzed. Analysis of the data showed a statistically significant change—at the 95% confidence level—in the average pressure detected before the wet wipe was brought into contact with an infant's skin (i.e., the baseline pattern of non-nutritive sucking events), and immediately after: an increase of 0.2 pounds per square inch was found. Analysis of data showed no statistically change in the average pressure detected before and after application of the warm wet tissue and dry tissue.

We claim:

1. A system for evaluating an infant's perception of the tactile qualities of an article of manufacture, the system comprising:
a sensor adapted to detect non-nutritive sucking events produced by an infant;
an article of manufacture having a tactile quality; and
an information device operatively connected to the sensor, said information device adapted to accomplish one or more of receiving, storing, processing, displaying, or transmitting information corresponding to non-nutritive sucking events detected by the sensor concurrent to the infant contacting the article of manufacture.

2. The system of claim 1 wherein the sensor is a pressure transducer adapted to detect the non-nutritive sucking events.

3. The system of claim 2 wherein the pressure transducer is attached to a pacifier.

4. The system of claim 1 wherein the information device is attached to a pacifier.

5. The system of claim 1 wherein the information device is operatively connected to the sensor by conductive wire, a pneumatic connection, a hydraulic connection, a connection using a portion of the electromagnetic spectrum, or some combination of these.

6. A method for evaluating an infant's perception of the tactile qualities of an article of manufacture, the method comprising the steps of:
(a) detecting non-nutritive sucking events produced by an infant; and
(b) relating the detected non-nutritive sucking events to the tactile qualities of a first article of manufacture.

7. The method of claim 6 further comprising:
repeating steps 6(a) and 6(b) for a second article of manufacture; and
comparing the detected non-nutritive sucking events produced by an infant in relation to the tactile qualities of the first article of manufacture to the detected non-nutritive sucking events produced by an infant in relation to the tactile qualities of the second article of manufacture.

8. The method of claim 7 further comprising communicating a message based on said relationship.

9. The method of claim 7 further comprising communicating a message based on said comparison.

10. A message adapted to be communicated, wherein the message comprises information produced using the system of claim 1.

11. A message referring to the tactile qualities of an article of manufacture and adapted to be communicated, wherein substantiation of the message is based on non-nutritive sucking events.

12. A research-and-development project directed to selecting a tactile quality for an article of manufacture, wherein said research-and-development effort comprises an evaluation of non-nutritive sucking events.

13. A method for evaluating an infant's perception of the tactile qualities of an article of manufacture, the method comprising the steps of:
(a) detecting non-nutritive sucking events produced by an infant concurrent to the infant contacting an article of manufacture;
(b) characterizing a property corresponding to a tactile quality of the article of manufacture; and
(c) relating the detected non-nutritive sucking events to the characterized property or tactile quality.

14. The method of claim 13 wherein the non-nutritive sucking events are detected, at least in part, while the infant is in an environment substantially devoid of sounds.

15. The method of claim 14 wherein the non-nutritive sucking events are detected, at least in part, while the infant is located in a substantially acoustically isolated environment.

16. The method of claim 13 wherein the non-nutritive sucking events are detected using a pacifier that wirelessly transmits data corresponding to the non-nutritive sucking events to a remote information device.

17. The method of claim 13 wherein the non-nutritive sucking events are detected using a pacifier model selected from a plurality of pacifier models available for conducting the evaluation.

18. The method of claim 13 wherein the non-nutritive sucking events are detected, at least in part, while the infant is sleeping.
